(19) United States
(12) Patent Application Publication
(10) Pub. No.: US 2011/0220237 A1
(43) Pub. Date: Sep. 15, 2011

(54) BIMETALLIC TUBE

(76) Inventor: Hiroki Okamoto, Sao Paulo (BR)

(21) Appl. No.: 13/046,188

(22) Filed: Mar. 11, 2011

(30) Foreign Application Priority Data
Mar. 15, 2010 (BR) 018100008896

(51) Int. Cl. F16L 9/18; B23P 19/00

(52) U.S. Cl. 138/140; 29/428

(57) ABSTRACT

A bimetallic tube comprising a copper tube and a steel tube within the copper tube. The copper tube is drawn down such that the inside wall surface of the copper tube is in intimate contact with the outside wall surface of the steel tube, and the copper tube is annealed.

### BACKGROUND OF THE INVENTION

This application claims priority from Brazilian Patent Application provisional No. 018100008896, filed 15 Mar. 2010, the whole contents of s which are incorporated herein by reference in their entirety.

1. Field of the Invention

The present invention relates to a bimetallic tube, apparatus comprising a bimetallic tube and a method of manufacturing an apparatus comprising a bimetallic tube.

2. Description of the Related Art

It is well known to use copper tubes within apparatuses such as refrigerators, freezers, air conditioning units, cookers, heating appliances, etc. The reason for choosing to use copper may be due to one or more of its properties, such as its resistance to corrosion, its pliability, allowing it to be easily shaped, its high thermal conductivity, etc. A problem with using such a copper tube is that copper has become very expensive. Consequently, in recent years it has been known to produce a bimetallic tube in which a copper plate layer is welded to the outside surface of a steel tube. Document CN 28881266 discloses such a bimetallic tube. A problem with such a tube relates to the complexity of manufacture due to the requirements of the welding process. In addition, if the weld between the inner surface of the copper and the outer surface of the steel is not perfectly formed, leakage of liquids or gasses between the steel and copper layers may occur.

### BRIEF SUMMARY OF THE INVENTION

According to a first aspect of the present invention, there is provided a bimetallic tube comprising: a copper tube; and a steel tube within the copper tube, characterised in that the copper tube is drawn down such that the inside wall surface of the copper tube is in intimate contact with the outside wall surface of the steel tube, and said copper tube is annealed.

According to a second aspect of the present invention, there is provided a method of manufacturing an apparatus comprising a bimetallic tube, said method comprising the steps of: providing a steel single walled tube; providing a straight copper tube; insertion of the steel tube within the copper tube to form a steel/copper composite tube; affixing the copper tube to the outside of the steel tube; and after the drawing process, annealing the composite tube within a furnace to reduce hardness of the composite tube, characterised in that the copper tube is affixed to the steel tube by a tube drawing process.

### BRIEF DESCRIPTION OF THE DRAWINGS

FIG. 1 shows a section of a bimetallic tube 101 embodying the present invention;

FIG. 2 shows a flow chart outlining a method of manufacturing the bimetallic tubing 101;

FIG. 3 shows the step 205 of drawing the composite tube;

FIGS. 4A and 4B show, respectively, the bimetallic tube 101 and a component 401 before coupling and after coupling by brazing;

FIGS. 5A and 5B show, respectively, the bimetallic tube 101 and a component 501 before coupling and after coupling by a compression sealing device 551;

FIGS. 6A and 6B show, respectively, the bimetallic tube 101 and a component 601 before coupling and after coupling by a compression sealing device 651;

FIGS. 7A and 7B show, respectively, the bimetallic tube 101 and a component 701 before coupling and after coupling by brazing;

FIG. 8 shows a portion of an apparatus 801 comprising a length of the bimetallic tubing 101 connected to a first component 802 and to a second component 804;

FIG. 9 shows a portion of an apparatus 901 comprising a length of the bimetallic tubing 101 connected to a first component 902 and to a second component 904; and

FIG. 10 shows a heat exchanger 1001 comprising a suction tube 1002 formed of a length of bimetallic tube 101.

### DETAILED DESCRIPTION OF EXAMPLE EMBODIMENTS

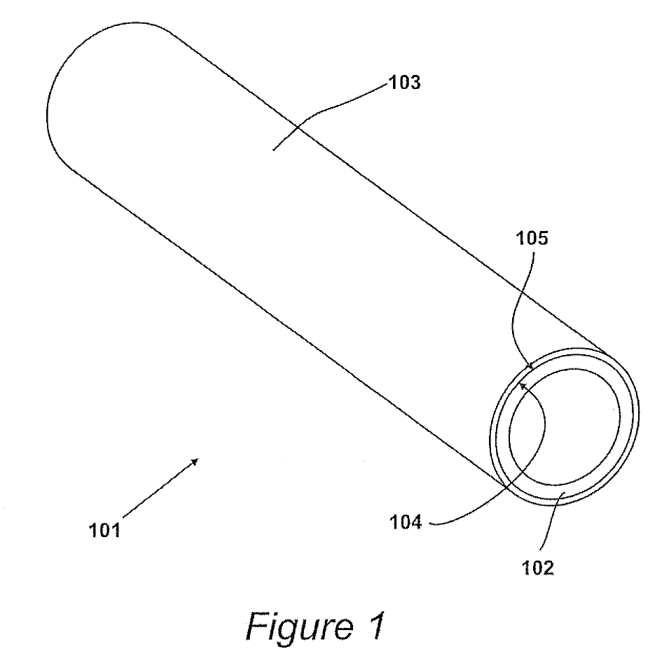

FIG. 1

A section of a bimetallic tube 101 embodying the present invention is shown in FIG. 1. The bimetallic tube comprises a cylindrical steel tube 102 located within a copper tube 103 such that the inside surface 104 of the wall of the copper tube 103 is in contact with the outside surface 105 of the wall of the steel tube 102. The inside wall surface 104 of the copper tube 103 is not adhered to the outside wall surface 105 of the steel tube 102 by any means such as brazing, other intermediate material such as adhesive, or by the copper tube being welded to the steel tube. However, the copper tube is tightly fitting over the steel tube so that the copper tube is maintained in position on the steel tube by frictional forces.

The choice of alloy from which the steel tube 102 is formed depends upon the application to which the tube is to be applied. However, in some embodiments the steel tube 102 is formed of a low carbon steel tube, having a carbon content of less than 0.03% by mass, and annealed to facilitate bending. In one such embodiment the steel tube has a relatively high titanium content as disclosed in European patent application number 05 784 561.2.

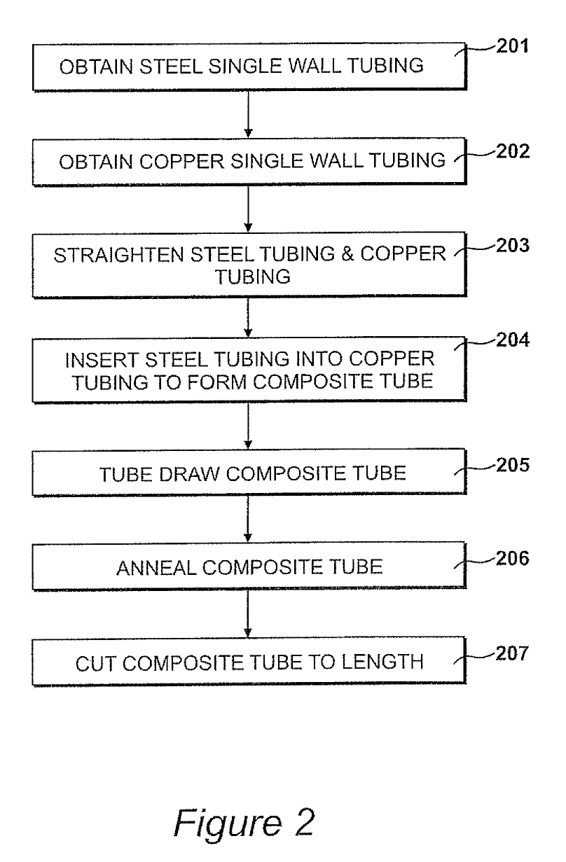

FIG. 2

A method of manufacturing the bimetallic tubing 101 of FIG. 1 is shown in a flow chart in FIG. 2.

Firstly at steps 201 and 202, steel single wall tubing and copper single wall tubing is obtained. The tubing obtained at steps 201 and 202 may be in the form of coils, in which case the tubing is straightened using known techniques at step 203. If required, the straight copper and steel tubing is also cut to length, for example, so that it will be of a length that can be accommodated in the annealing furnace (at step 206).

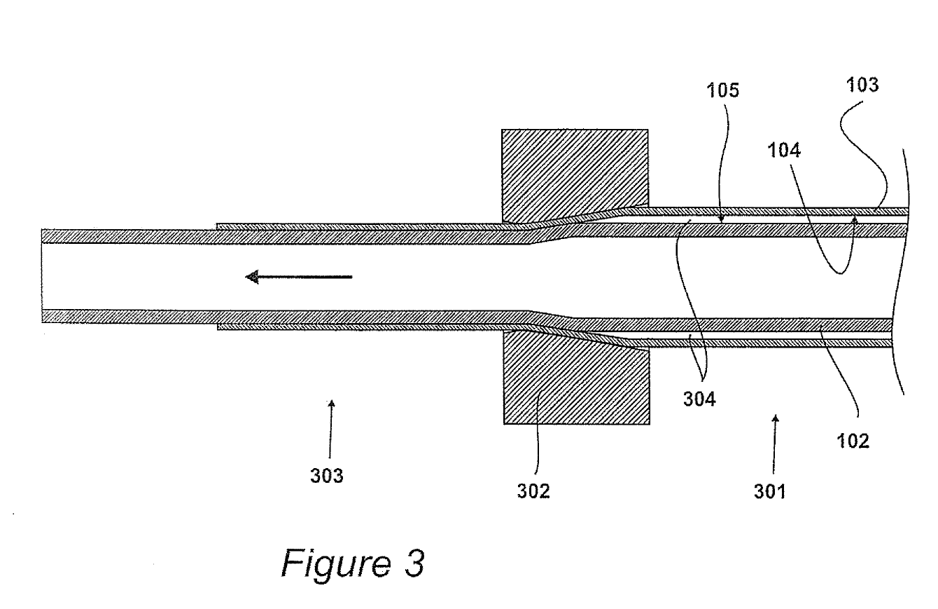

A length of straightened steel tubing is then inserted into straightened copper tubing, at step 204, such that an extended length of the steel tubing is enclosed within the copper tubing to form a composite tube. The composite tube is then drawn, as will be further described below with reference to FIG. 3, at step 205. During the tube drawing process of step 205, the copper tubing undergoes work hardening. Consequently, to make the finished composite tube pliable, the composite tube is annealed at step 206 before being cut to length at step 207. Typically, the composite tubing is annealed at step 206 at a temperature of between 850° C. and 950° C.

FIG. 3

The step 205 of drawing the composite tube is illustrated in FIG. 3 which shows a cross-sectional view of the copper tubing 103, the steel tubing 102 and a die 302. The process involves pulling the composite tubing 301 formed at step 204 through the die 302 to form the drawn composite tubing 303.

As illustrated in FIG. 3, initially there is a small gap 304 between the outside surface 105 of the steel tubing 102 and the inside wall surface 104 of the copper tubing 103. This gap 304 facilitates the earlier insertion of the steel tubing into the copper tubing. However, as the composite tubing 301 is pulled through the die 302 the copper tubing diameter is reduced until the inside surface 104 of the copper tubing presses against the outside surface 105 of the steel tubing such that, depending upon the relative tubing diameters chosen, the steel tubing is also reduced in diameter.

In one example of the present embodiment, the copper tubing initially has an outside diameter of 7 mm and an inside diameter of 6.6 mm, while the steel tubing initially has an outside diameter of 6 mm. After the tubing is drawn down, the copper tubing has an outside diameter of 6.0 mm while the steel tubing has an outside diameter of 5.6 mm and an inside diameter of 4.6 mm.

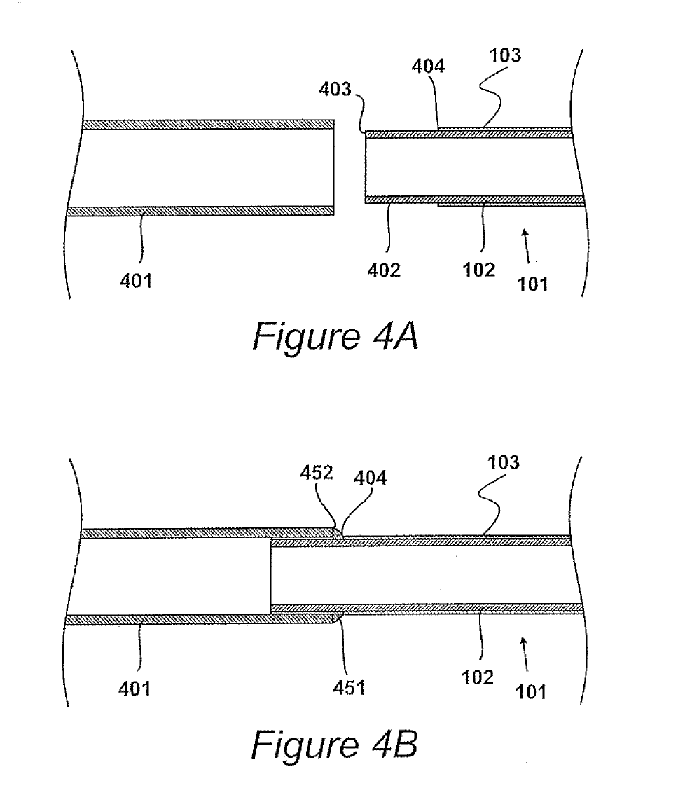

FIGS. 4A & 4B

Depending upon the application to which the tubing 101 is to be used, components may be connected to the tubing using a number of different methods. These methods fall into one of two categories depending upon the pressure of the fluid within the tubing 101 during its intended use. In all applications, and particularly where the fluid pressure within the tubing will be over 100 bar, the method of coupling the tubing to another component involves removal of an end portion of the copper tubing 103 adjacent to the end of the bimetallic tube 101. Thus, an end portion of the steel tubing 102 extends beyond the corresponding end of the copper tubing 103, typically by a distance of between 5 mm and 20 mm. For example, for a bimetallic tube of 8 mm diameter, copper tubing 103 is removed to expose a minimum of 10 mm of steel tubing 102.

A first example of such a coupling between the bimetallic tube 101 and another component 401 is illustrated in the cross-sectional views of FIGS. 4A and 4B. The bimetallic tube 101 and component 401 are shown before coupling in FIG. 4A and after coupling by brazing in FIG. 4B.

In the present method, firstly an end portion of the copper tubing 103 is removed from the end 403 of the bimetallic tubing 101 such that an end portion 402 of the steel tubing 102 extends beyond the end 404 of the copper tubing 103, as shown in FIG. 4A. In the present example, the bimetallic tubing 101 is to be connected to a component 401 in the form of a length of aluminium tubing having an inside diameter slightly larger than the outside diameter of the steel tubing 102.

The end portion of the copper tubing may be removed in a peeling process in which the end of the copper tubing 404 is defined by cutting using a lathe, or cutting machine in which a knife rotates around the copper tube. As the copper tubing 103 is not adhered to the steel tubing 102 it may be simply peeled off the steel tubing.

Having exposed the end portion 402 of the steel tubing 102 it is then inserted into the end of the component 401 and, in this method, it is then brazed in place using brazing material 451 as shown in FIG. 4B. The brazed material extends along the interface between the inside surface of the component 401 and the outside surface of the end portion 402 of the steel tubing 102 to form a leak-tight seal between the component 401 and the steel tubing 102. The brazed material 451 also extends between the end 452 of the component 401 and the end 404 of the copper tubing 103. Consequently, the copper tubing 103, the component 401 and the brazed material 451 protect the steel tubing 102 from the environmental conditions surrounding the joint between the bimetallic tube 101 and component 401.

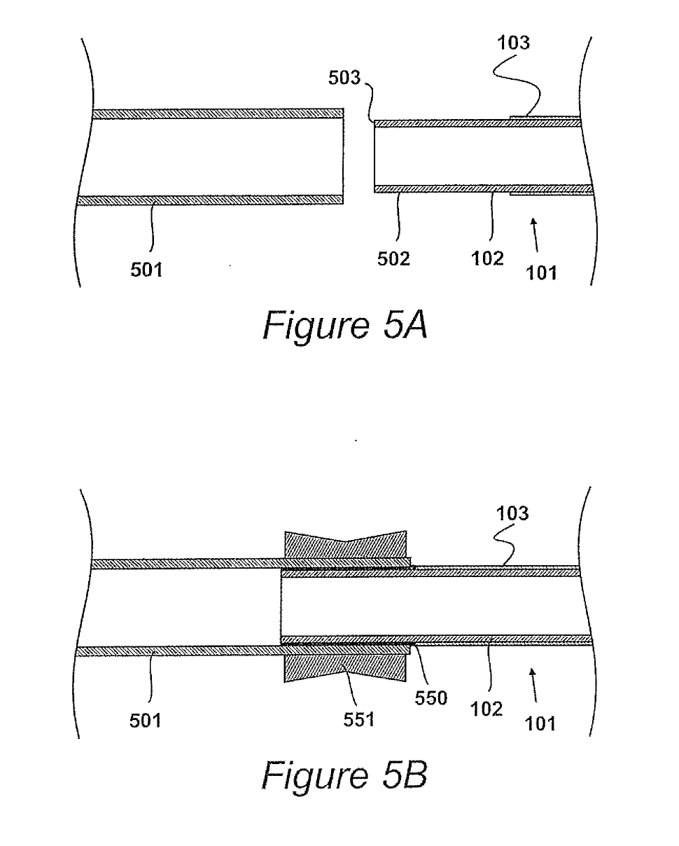

FIGS. 5A & 5B

The bimetallic tubing 101 lends itself to connection with other tubing using compression seal devices such as those sold under the brand name Lokring. An example of such a connection is illustrated in the cross-sectional views of FIGS. 5A and 5B.

Firstly as illustrated in FIG. 5A, an end portion of the copper tubing 103 is removed from the bimetallic tubing 101 to expose and end portion 502 of the steel tubing 102 adjacent to the end 503 of the bimetallic tubing. The length of the exposed portion 502 of the steel tubing is chosen to correspond to the length of the Lokring device 551 that is to be used.

In this example, the bimetallic tubing 101 is to be connected to a component 501 in the form of a length of aluminium tubing having an inside diameter slightly larger than the outside diameter of the steel tubing 102.

Having exposed the end portion 502 of the steel tubing 102, a sealing agent 550 is applied to the end portion 502. In the present example, the device 551 used to connect the tube 101 with the component 501 is a Lokring single ring connector. Consequently, the sealing agent 550 is an adhesive containing a methacrylic ester as sold under the brand name Lokprep.

The steel tubing 102 is then located within the end of the aluminium tube 501 and the two tubes (101 and 401) are connected using the compression sealing device 551 employing known techniques. The component 501 is shown connected to the bimetallic tube 101 by the compression sealing device in FIG. 5B.

In the example of FIGS. 5A and 5B the device made by Lokring is of a type in which two tubes of different diameters are connected. However, it will be understood that an alternative compression sealing device may be used that makes a first seal to a first tube and a second seal to a second tube. In this case the tubes are typically of the same diameter. A sealing device for forming a seal in this manner is also sold under the brand name Lokring.

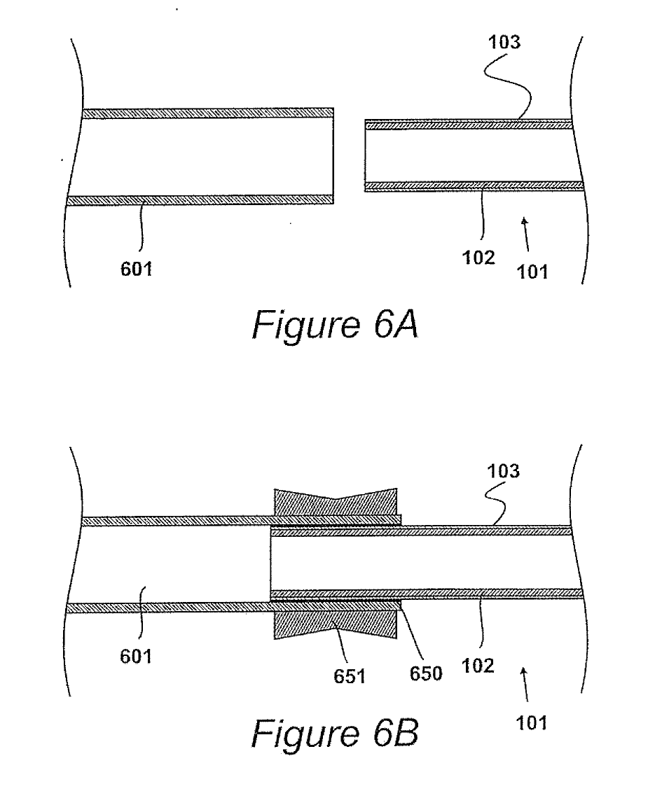

FIGS. 6A & 6B

For applications where the bimetallic tubing is intended to contain fluid up to pressures of 100 bar, it has been found that the bimetallic tubing 101 may be connected to other components using methods in which the other component is connected to the outer copper tubing 103 of the bimetallic tubing 101. An example of such a method is illustrated in the cross-sectional views of FIGS. 6A and 6B. The bimetallic tube 101 and a component 601 are shown before coupling in FIG. 6A and after coupling by a compression sealing device in FIG. 6B.

In this example, the bimetallic tubing 101 is to be connected to another component 601 in the form of metal tubing. Unlike the above described methods, this method does not require removal of the copper tubing 103 of the end portion of the steel tubing 102. Thus, as illustrated in FIG. 6A, the complete bimetallic tubing 101 may be brought together with the component 601. In the present method, the end portion of the bimetallic tube 101 is coated with sealing agent 650 and then inserted into the end of the tube 601. The two tubes (101 and 601) are then connected together using a compression seal device 651 as illustrated in FIG. 6B. In the present example, the compression seal device 651 is a single ring connector as sold under the brand name Lokring, and the sealing agent is an adhesive containing methacrylic ester. As shown in FIG. 6B, the two tubes 101 and 601 are connected such that the outer surface of the copper tubing 103 is sealed against the inside surface of the tubing 601.

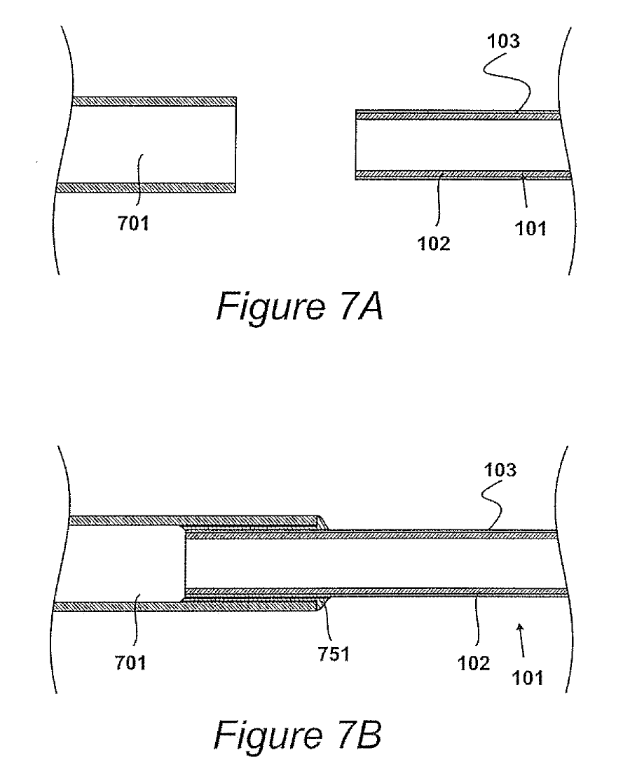

FIGS. 7A & 7B

A second example of a method in which the bimetallic tubing 101 is connected to another component without any removal of the copper tubing 103 from the outer surface of the steel tubing 102 is shown in the cross-sectional views of FIGS. 7A and 7B.

In the present method, the bimetallic tubing 101 is to be connected to a component 701 comprising metallic tubing. The inside diameter of the metallic tubing 701 is arranged to be slightly larger than the outside diameter of the bimetallic tube 101 such that an end portion of the bimetallic tubing 101 may be inserted into the end of the tubing 701 and brazed in place. Thus, as shown in FIG. 7B, the bimetallic tubing 101 is connected to the component 701 by brazed material filling the gap between the inside surface of the component 701 and the outer surface of the copper tubing 103. Thus, the brazed material 751 provides a leak-tight seal between the copper tubing 103 and the component 701.

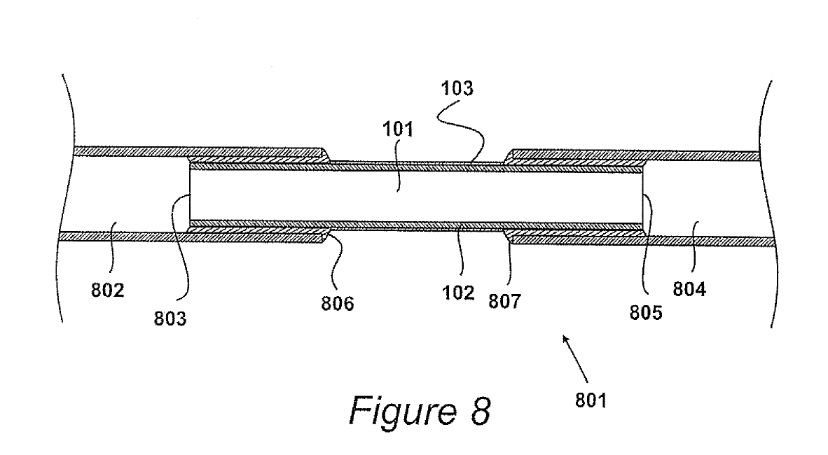

FIG. 8

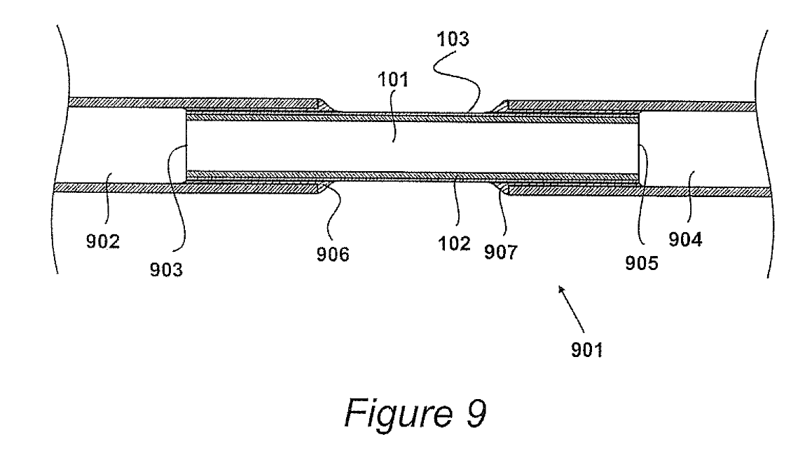

By way of example, a portion of an apparatus 801 is shown in FIG. 9 comprising a length of the bimetallic tubing 101 having a first component 802 connected to a first end 803 of the bimetallic tubing 101 and a second component 804 connected to the opposite end 805 of the tubing 101.

In this example, end portions of the copper tubing 103 have been removed from the bimetallic tubing. Thus, the bimetallic tubing 101 is connected to the components 802 and 804 by braze joints 806 and 807 formed between the steel tubing 102 of the bimetallic tubing 101 and the components 802 and 804. The component 802, the steel tubing 102 and the second component 804 form a leak-tight conduit for fluid.

In this apparatus (801) the braze material 806 and 807 extends over the end portions of the steel tube 102 that have been stripped of their copper protective layer (copper tubing 103) and provides the steel tube 102 with protection from the surrounding environment during use. For example, the braze material 606 and 807 prevents atmospheric oxygen and water from accessing the outer surface of the steel, and so prevents corrosion. For this reason, it is preferable for the braze to seal against the ends of the copper tubing 103. However, this is not necessary for the components 802 and 804 along with the bimetallic tube 101 forming a leak-tight conduit for a fluid.

FIG. 9

By way of example, a portion of an apparatus 901 is shown in FIG. 8 comprising a length of the bimetallic tubing 101 having a first component 902 connected to a first end 903 of the bimetallic tubing 101 and a second component 904 connected to the opposite end 905 of the tubing 101. In this example, the bimetallic tubing 101 is connected to the components 902 and 904 by braze joints 906 and 907 formed between the copper tubing 103 of the bimetallic tubing 101 and the components 902 and 904. Thus, the component 902, the copper tubing 103 and the second component 904 form a leak-tight conduit for fluid.

It may be noted that the steel tube 102 is a tight fit within the copper tubing 103 but the outer surface of the steel tubing 102 is not adhered to the inner surface of the copper tubing 103. Consequently, it is possible that fluid may enter into the interface between the steel tube 102 and the copper tubing 103, but as both ends of this interface are maintained inside respective ones of the two components 902 and 904 no fluid is able to escape from the conduit formed by these three components. Thus, if any fluid is able to leak into the interface between the steel tubing 102 and the copper tubing 103, this does not create a problem provided the components 902 and 904 are both sealed to the copper tubing 103. So, in this embodiment, the copper tubing 103 provides the leak-tight conduit for fluid between components 902 and 904, while the steel tubing 102 merely provides mechanical support for the copper tubing 103.

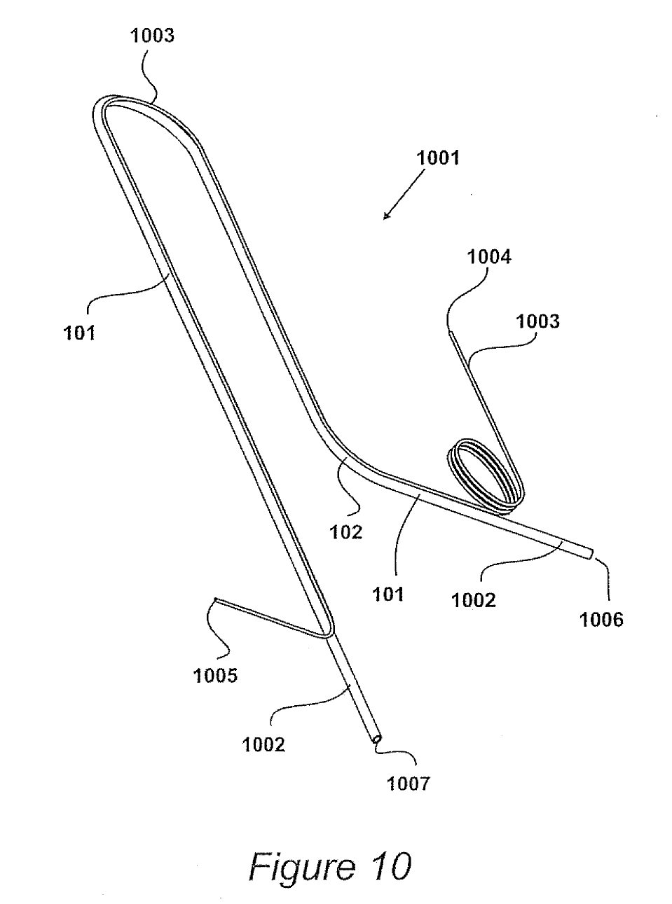

FIG. 10

An example of apparatus 1001 employing the bimetallic tubing 101 is shown in FIG. 10.

The apparatus 1001 is a heat exchanger for use in a refrigeration unit and comprises a suction tube 1002 formed of a length of bimetallic tube 101 to which has been affixed, along a portion of its length, a copper capillary tube 1003. (In the present example, the capillary tube 1003 is affixed to the copper tubing 103 of the suction tube 1002 by soldering.)

Typically, in use, one end 1004 of the capillary tube 1003 is connected to a condenser of a refrigeration system while the opposite end 1005 of the capillary tube is connected to the inlet of an evaporator of the refrigeration system. Typically, one end 1006 of the suction tube 1002 is connected to the compressor of the refrigeration system, while the opposite end 1007 of the suction tube 1002 is connected to the outlet of the evaporator via an accumulator.

As it will now be understood, the ends 1006 and 1007 of the suction tube may be connected to the relevant components of the refrigeration system using the above described methods. However, where connection is made to one end of the suction tube 1002 by sealing to the copper tube 103 forming its outer surface then the other end of the suction tube 1002 must also be connected by sealing to the copper tubing 103. Alternatively, a portion of the suction tube 1002 at each of its ends 1006 and 1007 is stripped of its outer copper tubing layer (103) to expose a portion of steel tubing and the steel tubing 102 is then connected to the relevant components using a method such as those illustrated in FIGS. 4A and 4B or 5A and 5B.

The apparatus 1001 of FIG. 10 is one example of the use of the bimetallic tubing 101, but many other uses are envisaged. For example, other embodiments are envisaged in which the bimetallic tubing is used to carry refrigerant in a refrigeration or air conditioning system. In one such apparatus, the bimetallic tube 101 is formed into coils for use as an evaporator in a refrigeration unit. In other different embodiments the bimetallic tubing 101 is used to carry gas in a gas appliance, such as a cooker.

1. A bimetallic tube comprising:
a copper tube; and
a steel tube within the copper tube;
wherein the copper tube is drawn down such that the inside wall surface of the copper tube is in intimate contact with the outside wall surface of the steel tube, and
said copper tube is annealed.

2. The bimetallic tube of claim 1, wherein the inside wall surface of said copper tube is not adhered to the outside wall surface of said steel tube.

3. The bimetallic tube of claim 1, wherein said copper tube is maintained in position on said steel tube by frictional forces.

4. The bimetallic tube of claim 1, wherein said steel tube comprises a low carbon steel tube.

5. The bimetallic tube of claim 4, wherein the steel tube comprises less than 0.03% by mass of carbon.

6. Apparatus comprising:
the bimetallic tube of claim 1;
a first component connected to a first end of said bimetallic tube; and
a second component connected to a second end of said bimetallic tube,
wherein said first component and said second component are connected to said bimetallic tube such that a fluid is transportable from said first component through said bimetallic tube to said second component, and said first and second components are joined to said copper tube by connection means providing a leak-tight seal for preventing leakage of fluid from said apparatus.

7. Apparatus comprising:
the bimetallic tube of claim 1;
a component connected to a first end of said bimetallic tube; and
wherein said component is connected to said bimetallic tube such that a fluid is transportable from said component through said tube, an end portion of said steel tube extends beyond the corresponding end of the copper tube and said component is joined to said steel tube by a connection means providing a leak-tight seal for preventing leakage of fluid from said apparatus.

8. Apparatus according to claim 7 wherein the connection means for connecting the component to the steel tube also provides a cover over said end portion of said steel tube to provide protection against corrosion.

9. Apparatus according to claim 7 wherein said connection means for connecting the component to the steel tube comprises braze material.

10. Apparatus according to claim 7 wherein said means for connecting the component to the steel tube comprises a compression seal device.

11. Apparatus according to claim 6 wherein said apparatus forms a part of larger apparatus selected from a group comprising: a refrigeration apparatus; an air conditioning apparatus; cooking apparatus; and heating apparatus.

12. A method of manufacturing an apparatus comprising a bimetallic tube, said method comprising the steps of:
providing a steel single walled tube;
providing a straight copper tube;
insertion of the steel tube within the copper tube to form a steel/copper composite tube;
affixing the copper tube to the outside of the steel tube; and
after the affixing process, annealing the composite tube within a furnace to reduce hardness of the composite tube,
characterised in that the copper tube is affixed to the steel tube by a tube drawing process.

13. The method of manufacturing according to claim 12, wherein said method comprises the further step of cutting the composite tube to a desired length after the step of annealing.

14. The method of manufacturing of according to claim 12, further comprising the step of removing a portion of said copper tube adjacent to an end of said bimetallic tube to expose an end portion of said steel tube.

15. The method of manufacturing according to claim 12, further comprising the step of locating end portions of said composite tube within other components and sealing said other components to the copper tube of said composite tube to form a leak-tight conduit for fluid.
